(19) United States
(12) Patent Application Publication
(10) Pub. No.: US 2011/0057007 A1
(43) Pub. Date: Mar. 10, 2011

(54) Motorcycle Carrying Device with Reversed Rake

(76) Inventor: Thomas J. Conroy, JR., Verona, NJ (US)

(21) Appl. No.: 12/554,501

(22) Filed: Sep. 4, 2009

(51) Int. Cl. B62J 7/04

(52) U.S. Cl. 224/413; 224/433

(57) ABSTRACT

The technology is of a device which comprises a rear-positioned carrier positioned at an angle substantially congruent to a rake of the motorcycle when the angle is measured counterclockwise from a vertical axis of the motorcycle when viewing a left side of the motorcycle. The device further comprises two supporting arms which further comprise mounting fingers which connect to a passenger rest slot, so that the article carrier is fixedly, but removably, attached to a motorcycle without a need for permanent modifications to the hull of the motorcycle.

### FIELD OF THE DISCLOSED TECHNOLOGY

The disclosed technology relates generally to a carrier for transporting a golf bag on a motorcycle and more specifically to a rear-positioned carrier having the ability to be positioned opposite to the rake of the bike.

### BACKGROUND OF THE DISCLOSED TECHNOLOGY

When a person travels to a destination, often they must bring luggage along for the trip. While automobiles provide ample luggage storage space for most individuals and families, this isn't the case with smaller vehicles. For example, a golfer traveling to the golf course will often want to bring his clubs with him. Likewise, a skier may want to bring his own skis to the slopes. A hunter may wish to bring along his shotgun for the hunt, and a fisherman may want to bring his bait and tackle. While driving by motorcycle has many benefits, such as less use of gas, lower toll costs, excitement, easier parking, and enjoyment of a nice day, as well benefits to the greater community such as producing less green house gases, their cargo space is limited. Each of the individuals described above will likely not choose to take his motorcycle to his destination because his cargo simply will not fit.

Therefore, motorcyclists are left with a choice of doing without bringing their own goods, e.g. golf clubs, skis, guns, and the like, or simply resorting to the use of an automobile having greater storage space. While prior art devices add luggage or storage space to motorcycles, safety with motorcycles is a huge concern. Further, the need to modify the motorcycle itself, including costly and sometimes irreversible modifications, cause damage to the hull of the bike, limit the usefulness of such devices, and may further compromise safety. Still further, many prior art devices are diagonally, horizontally, or high mounts which are unstable because the weight is off-center or the center of gravity of the bike is raised further from the ground.

For example, U.S. Patent Publication 2005/0258207 to Sadler discloses a rear golf bag support engageable with a seat back of a motorcycle. While Sadler discloses a carrying device for a motorcycle, such a device requires modification to the motorcycle itself, including removing of a rear seat allowing for less passenger space, which may offset any gains in storage space. Safety of such a device is also a concern, as the addition of any rear storage compartment (including the Sadler device) may effect the factory balancing of weight of a motorcycle, thus making the bike less stable.

U.S. Pat. No. 3,286,891 to Jones, Jr. discloses a carrier attachment for two wheel vehicles attaching at the rear via rearly disposed brackets, again, having the safety issues described above, and further requiring substantial and permanent modification (e.g. new screw holes) into the body of a motorcycle. Making modifications to a motorcycle is often undesired, decreases value of the bike, hurts the aesthetic appeal of the bike and makes it difficult to add/remove such an attachment, as needed.

There is a need in the art to provide the benefits of motorcycles along with the benefits of greater storage space found in larger vehicles. There is further a need to provide this greater storage space without compromising on safety or causing damage/undue modification to the motorcycle itself.

### SUMMARY OF THE DISCLOSED TECHNOLOGY

It is therefore an object of the disclosed technology to provide a safe carrying device for carrying luggage, such as golf clubs, on a motorcycle that without requiring permanent modification to the motorcycle.

It is a further object of the disclosed technology to provide a carrying device for a motorcycle which maintains stability and balance of the motorcycle. This is accomplished by having a lower profile (and thereby, lower center of gravity) and centered position of the carrying device.

Embodiments of the disclosed technology provide an article carrier for a motorcycle comprising two spaced apart supporting arms. Each of the supporting arms has a proximal region fixedly attached to a basket of the article carrier, and a distal region comprising a mounting finger extending angularly, such as at an acute angle, from each supporting arm. Each mounting finger is adapted for engagement with a passenger rest slot of the motorcycle. Kicker supports extending substantially at converging angles from proximal and distal regions of supporting arms join at a mounting flange. Each mounting flange is adapted for support by a rear bolt in the fender strut.

An embodiment of the enclosed technology further comprises a support extending from near the proximal region of the supporting arms and fixedly attached to a minimum of three spaced apart spindles, forming a shelf. A further embodiment of the disclosed technology comprises an accessory rack, where the accessory rack comprises at least three supports extending between the supporting arms.

In a further embodiment of the disclosed technology, the article carrier is elongated and may hold golf clubs. An attached article carrier forms an angle, measured counterclockwise from a vertical access of the motorcycle when viewing the left side of a motorcycle, that is substantially congruent to the rake angle of the motorcycle. The article carrier has two opposite ends separated by a plurality of spindles, where one of the ends is open and the other end is closed.

### BRIEF DESCRIPTION OF THE DRAWINGS

FIG. 1 shows a side view of a motorcycle with carrier in an embodiment of the disclosed technology.

FIG. 2 shows a side perspective view of a carrier in an embodiment of the disclosed technology.

FIG. 3 shows a connecting region of the carrier of FIG. 2 from a reverse angle.

FIG. 4 shows a side view of a rear portion of a motorcycle with carrier attached in an embodiment of the disclosed technology.

FIG. 5 shows a perspective of a rear portion of a motorcycle with carrier attached in an embodiment of the disclosed technology.

FIG. 6 shows a rear view of a carrier attached to a motorcycle in an embodiment of the disclosed technology.

FIG. 7 shows a rear view of a carrier in an embodiment of the disclosed technology.

FIG. 8 shows a left side view of a carrier in an embodiment of the disclosed technology.

FIG. 9 shows a top perspective view of a carrier in an embodiment of the disclosed technology.

FIG. 10 shows a bottom perspective view of a carrier in an embodiment of the disclosed technology.

### DETAILED DESCRIPTION OF EMBODIMENTS OF THE DISCLOSED TECHNOLOGY

Embodiments of the disclosed technology comprise a rear-positioned carrier positioned at an angle substantially congruent to a rake of the motorcycle when the angle is measured counterclockwise from a vertical axis of the motorcycle when viewing a left side of the motorcycle. For purposes of this disclosure, substantially congruent is defined as being equal in magnitude with an error within 1, 2, 5, or 10 degrees. When the angle of the article carrier is equal or substantially equal in offset from the vertical axis of a motorcycle to the rake angle (e.g. congruent), the motorcycle is optimally balanced symmetrically and aesthetically. The sides of the carrier, in embodiments of the disclosed technology, extends outward from the motorcycle either no greater than the body of the bike itself, or at least not greater than the far lateral reaches of the front wheel when in a fully turned condition. This adds to the stability, balance, and rideability of the motorcycle, thereby promoting safety.

Furthermore, an embodiment of the disclosed technology comprises two supporting arms further comprising mounting fingers which connect to a passenger rest slot. In this manner, each of the mounting flanges engage with and secure into an aperture of a rear fender strut, such as the left and right rear fender struts, of the motorcycle. When the mounting fingers are secured into the passenger rest slot, the article carrier is fixedly, but removably, attached to a motorcycle without a need for permanent modifications to the hull of same.

The disclosed technology will become clearer in light of the description of the figures.

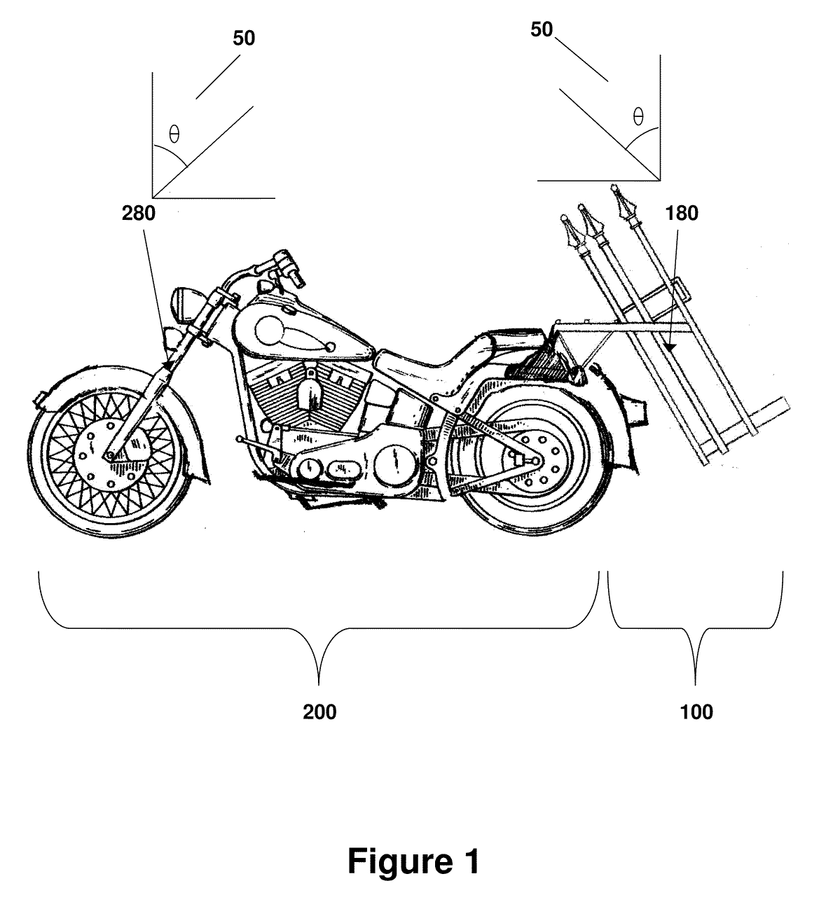

FIG. 1 shows a side view of a motorcycle with carrier whereby the motorcycle rake and carrier comprise congruent angles in an embodiment of the disclosed technology. In the example displayed in FIG. 1, the article carrier 100 is attached to a motorcycle 200. The article carrier 100 comprises a cylindrical basket region 180 for carrying luggage. The motorcycle has a rake angle 50 (meaning, label 50 and not necessarily a 50 degree angle) which, as is known in the art of motorcycle geometry, is an angular measurement of the length of a steering axis 280 clock-wise from a vertical axis of the motorcycle when viewed from the left side of a motorcycle. The carrier 100 is connected to the motorcycle at an angle 50 that is substantially congruent to the rake angle 50. The angle of the article carrier is measured from the longitudinal axis of the article carrier (which is parallel to the length of a basket region 180) counter-clockwise from a vertical axis when viewed from the left side of a motorcycle. For an embodiment of the disclosed technology, substantially congruent is defined as two angles being equal in magnitude with an error within 1, 2, 5, or 10 degrees. The rake angle 50 of the motorcycle/angle 50 of the article carrier 100, may be any acute angle, using the y-axis as a reference line.

It should be understood that the leather strapping shown in the figures and wrapped around elements of the article carrier is optional. It may be added for aesthetic purposes, such as to match the aesthetic characteristics of the motorcycle, or otherwise.

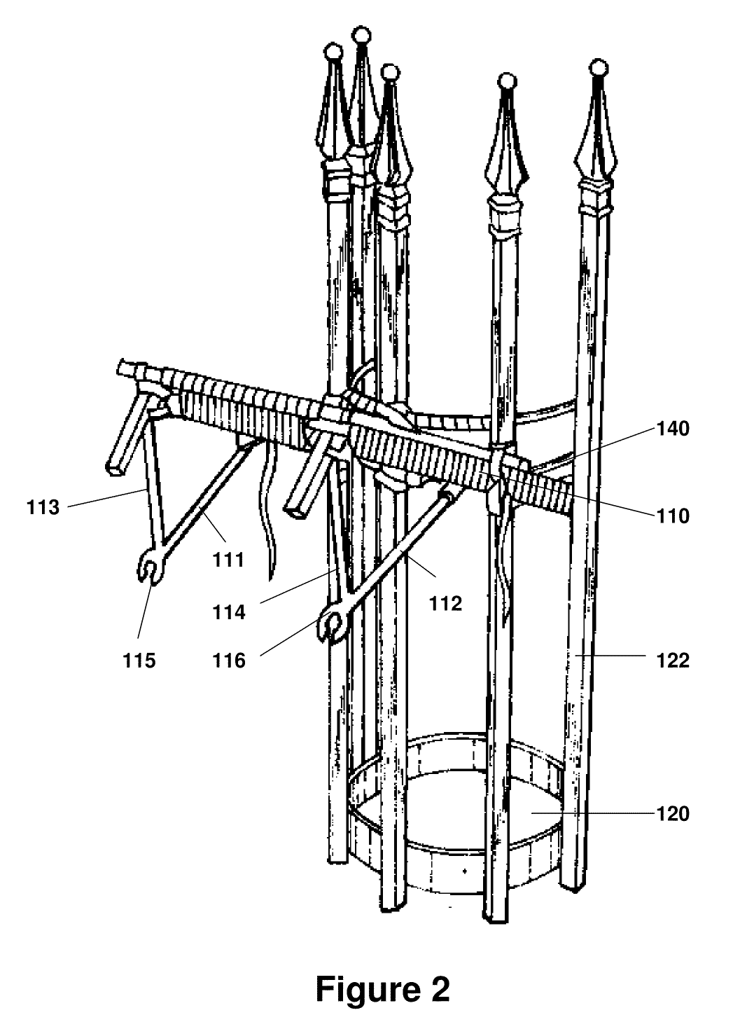

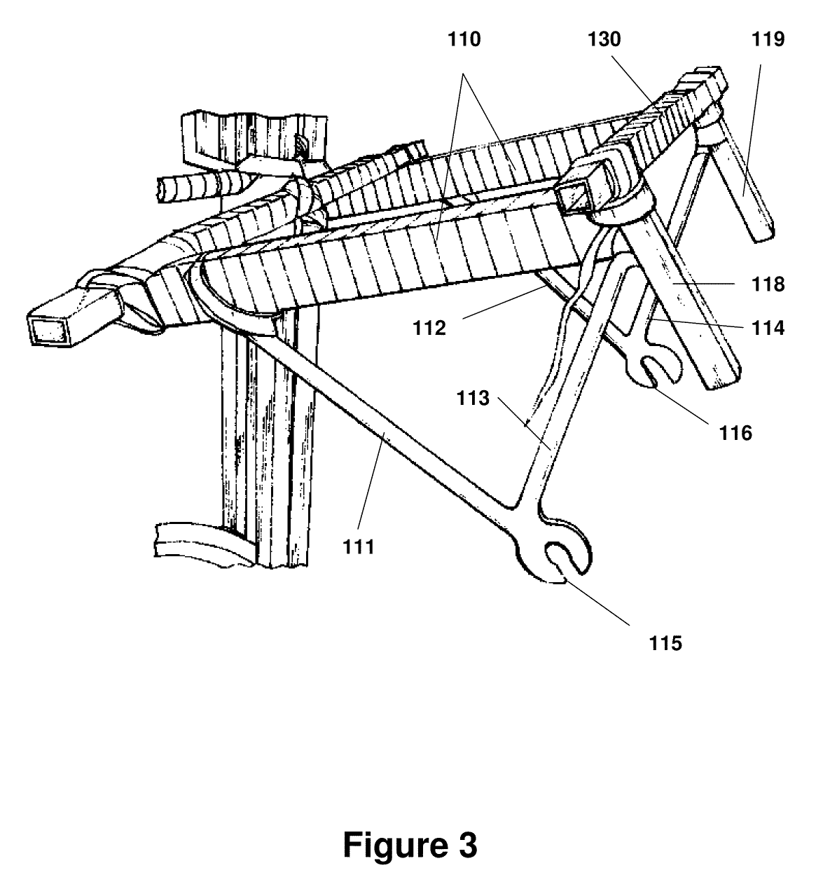

FIG. 2 shows a side perspective view of a carrier in an embodiment of the disclosed technology, and FIG. 3 shows a connecting region of the carrier of FIG. 2 from a reverse angle. In an embodiment of the disclosed technology, the article carrier 100 has two spaced apart parallel or substantially parallel supporting arms 110. Substantially parallel is defined as appearing parallel to a casual observer of the article carrier or within an acceptable tolerance level known in the art. Each supporting arm 110 is comprised of a distal region and a proximal region. (The distal region is closer to a motorcycle and the proximal region is further from the bike when the article carrier is attached to a motorcycle. In embodiments of the disclosed technology, the supporting arms are constructed of solid or hollow metal or other applicable solids or composites. An embodiment of the disclosed technology comprises a supporting arm which may be constructed out of ¾ inch by 1 inch hollow metal stock.

In an embodiment of the disclosed technology, as displayed in the example shown in FIG. 2 and FIG. 3, comprises proximal regions of the left and the right supporting arms 110 forming a unitary structure with a basket region 180 of the article carrier. Furthermore, an embodiment comprises a support 130 extending perpendicularly from the proximal region of each supporting arm 110, and connecting the left and the right supportive arm.

In an embodiment of the disclosed technology, the left and right supporting arms comprise respective left and right front kicker supports 114, 113 and left and right rear kicker supports 112, 111 converging towards each other (e.g. at converging angles whereby the non-shared sides of the adjacent angles converge at respective vertices, the mounting flanges 115 and 116). Each of the left kicker supports 112 and 114 terminate at a left mounting flange 116 and each of the right kicker supports 111, 113 terminate at a right mounting flange 115. In an embodiment of the disclosed technology, the mounting flange is capable of attachment to a rear fender strut of a motorcycle with out requiring permanent modifications to the motorcycle. That is, the carrier is attached to a bike in a permanent modificationless manner. A mounting flange, such as flange 115 and 116, has the a style that is either raised face, flat face, tongue and groove, ring joint, a combination thereof, or other styles as are known in the art.

A left mounting finger 119 and a right mounting finger 118 extend angularly from a distal region of a left and right supportive arm. In an embodiment of the disclosed technology, as shown in the example in FIG. 2 and FIG. 3, at an end of the distal region (furthest away from the basket 180 of the article carrier), mounting fingers 118, 119 extend angularly therefrom and are adapted for engagement with corresponding left and right passenger rest slots of the motorcycle 200. In embodiments of the disclosed technology, the angle between the length of a mounting finger 118, 119 and the length of an adjacent supporting arm 110 is such that the length of the supporting arm is substantially parallel to a horizontal axis of the motorcycle 200 when the mounting fingers 118, 119 are attached to a passenger rest slot of a motorcycle. The length of each mounting finger 118 or 119 is substantially perpendicular to the length of a support 130, in embodiments. Substantially parallel and substantially perpendicular are defined as appearing parallel and perpendicular, respectively, to a causal observer of the article carrier 100 or within an acceptable tolerance level known in the art.

An embodiment of the disclosed technology comprises a supporting arm 110 constructed out of ½ inch width hollow metal, kicker supports 111, 112, 113, 114 constructed out of ⅜ inch diameter metal, a mounting flange 115, 116 made from ⅛ inch metal, and mounting fingers 118 and 119 constructed out of ½ inch width metal.

In an embodiment of the disclosed technology, the basket region 180 is comprised of a plurality of spaced apart spindles 112 and has two ends, wherein a first end is closed and an opposite second end is either fully or partially open. Furthermore, in an example of the disclosed technology, the lower end of a basket region is a closed end and it is comprised of a pan 120 for the purpose of securing luggage. Furthermore, a pan 120 may be solid, contain weep holes or other breaks, be weaved, made from fabric or leather, a combination thereof, or the like.

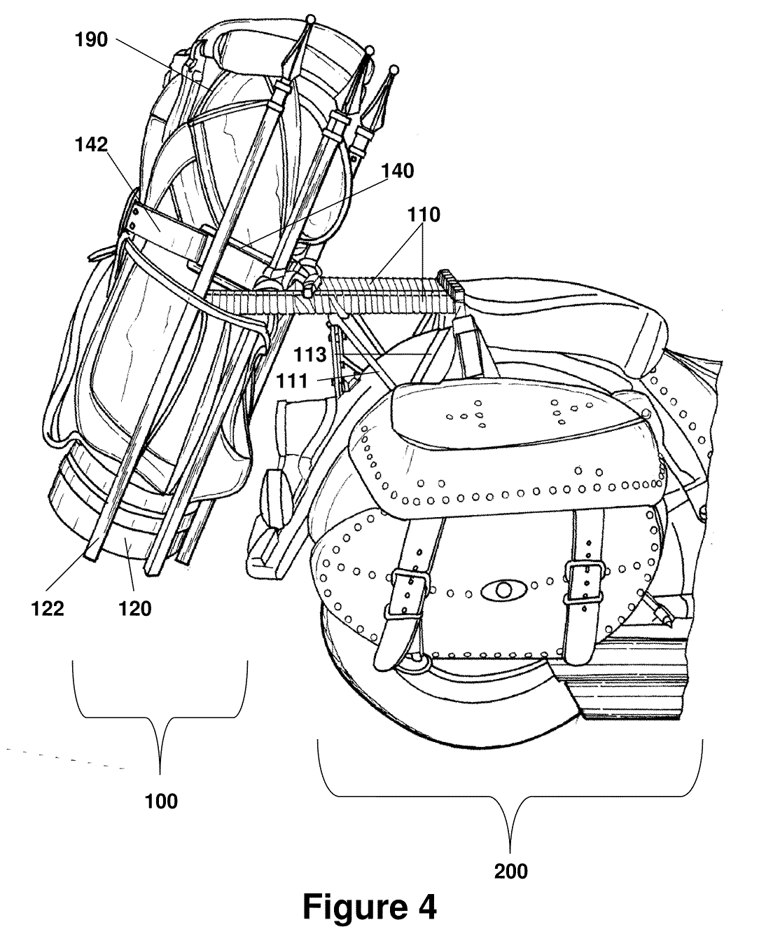

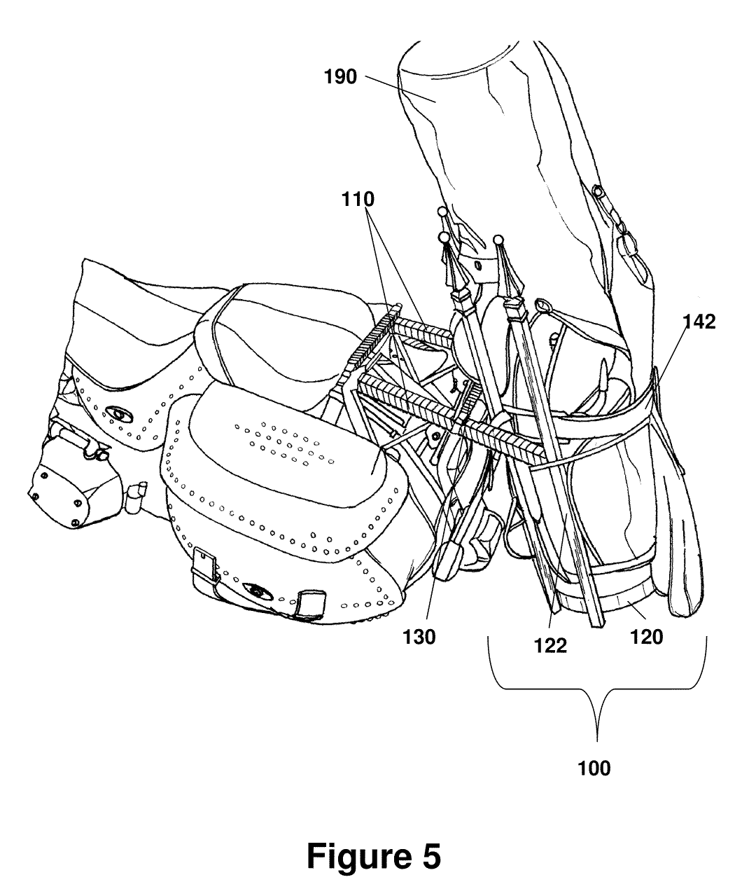

FIG. 4 shows a side view of a rear portion of a motorcycle with carrier attached in an embodiment of the disclosed technology. FIG. 5 shows a perspective of a rear portion of a motorcycle with carrier attached in an embodiment of the disclosed technology. In the carrier shown in FIG. 4 and FIG. 5, the carrier 100 is holding luggage 190, which is a golf bag. In further embodiments of the disclosed technology, luggage 190 may comprise any one of golf clubs, a carrying case, guns, skis, sports equipment, and the like.

In an embodiment of the disclosed technology, a left and right supporting arm 110 each contain two kicker supports that converge at a mounting flange 115, 116 which is connected to a respective left and right rear fender strut of a motorcycle. In FIG. 4 and FIG. 5, the mounting fingers 118 and 119 are implanted into a passenger rest slot of the motorcycle 200.

In embodiments of the disclosed technology, as displayed in FIG. 4 and FIG. 5, the luggage 190 is supported by a pan 120 of the basket region 180. In an embodiment of the disclosed technology, the luggage is further secured laterally by a plurality of substantially parallel spindles 122. In further embodiments of the disclosed technology, the luggage may be secured laterally or otherwise by securing belts, straps, buckles, chains, gates, coverings, enclosures, spindles 122, or a combination thereof.

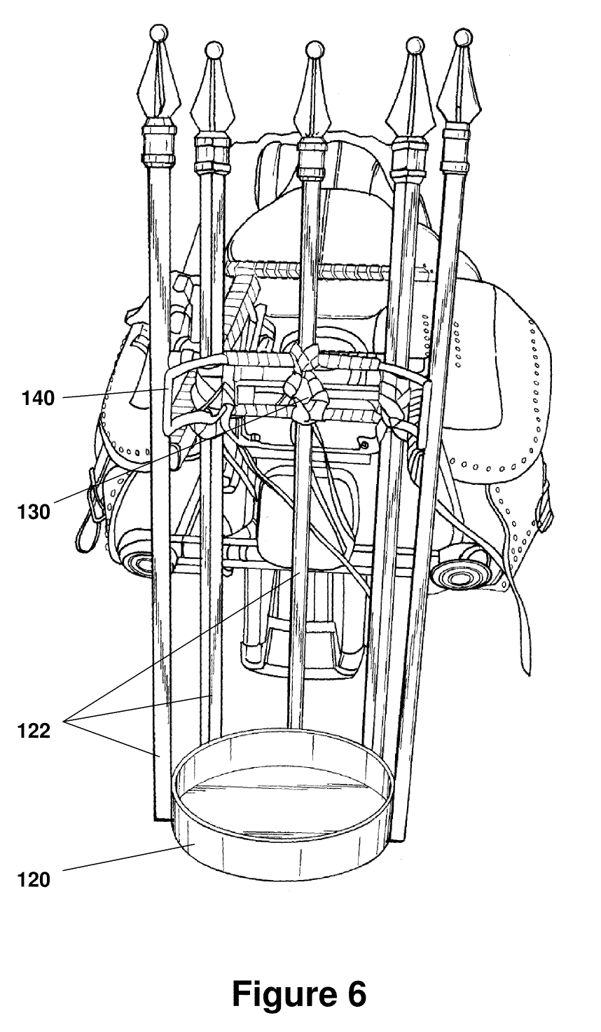

FIG. 6 shows a rear view of a carrier attached to a motorcycle in an embodiment of the disclosed technology. The basket 180 is attached to a motorcycle 200 by a support extending from near the proximal region of the supporting arms that is attached to at least three spaced apart spindles 122 or other components that comprises the basket. In an embodiment of the disclosed technology, the basket 180 is further secured within the article carrier 100 by attachment to a support 130 (see FIG. 3). In the example displayed in FIG. 6, the spindles 122 are attached to a support 130 and a proximal region of a supporting arm 110 by either elastic, fabric, bandage, leather, hardware fasteners, a combination thereof, or the like.

Furthermore, in an embodiment of the disclosed technology, as displayed in FIG. 6, a pan 120 is attached to a plurality of spindles to provide support for luggage 190 that is placed within the article carrier.

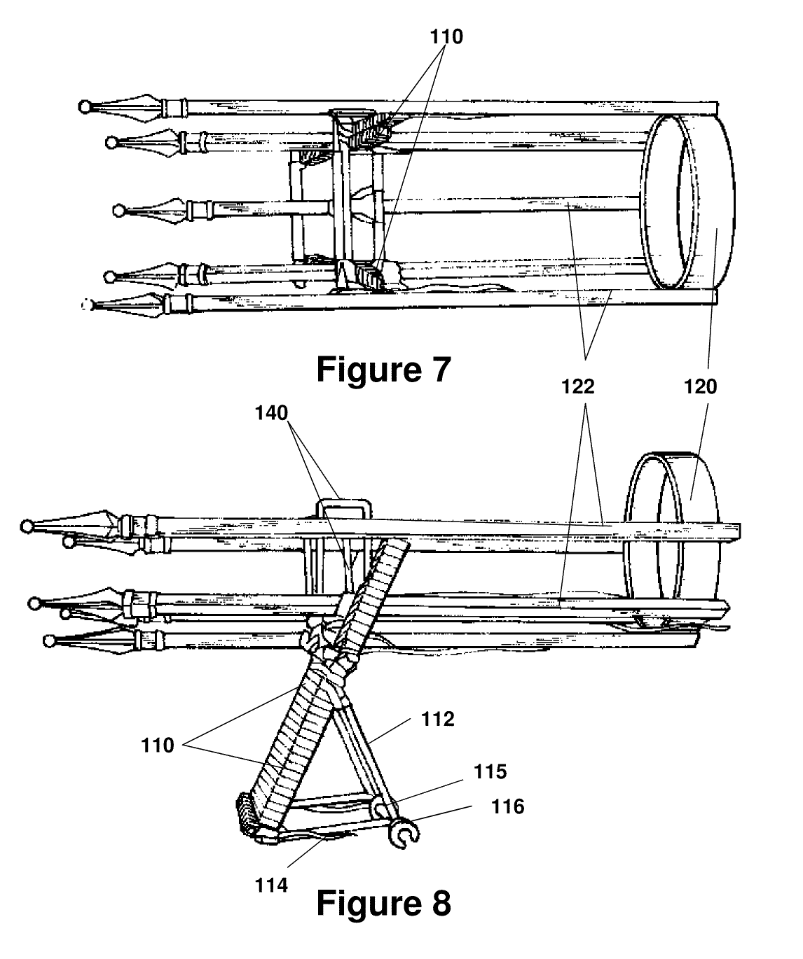

FIG. 7 shows a rear view of a carrier in an embodiment of the disclosed technology. Furthermore, FIG. 8 shows a left side view of a carrier in an embodiment of the disclosed technology. In an embodiment of the disclosed technology, a proximal region of the supporting arms 110 forms a unitary structure with at least three spindles 122 of a basket 180. A basket further comprises of a pan 120 for support of luggage 190.

FIG. 8 shows a left side view of a carrier in an embodiment of the disclosed technology. Referring to FIG. 8, and in addition, FIG. 3, the distal region of the left and right supporting arms 110, are fixedly attached to respective left and right front kicker supports 111, 112 and a left and right rear kicker supports 113, 114. Each of the left kicker supports 112 terminate at a left mounting flange 115 and each of the right kicker supports 114 terminate at a right mounting flange 116. In an embodiment of the disclosed technology, the mounting flange is capable of attachment to a rear fender strut of a motorcycle in a modificationless manner (with no need for permanent modifications to the motorcycle).

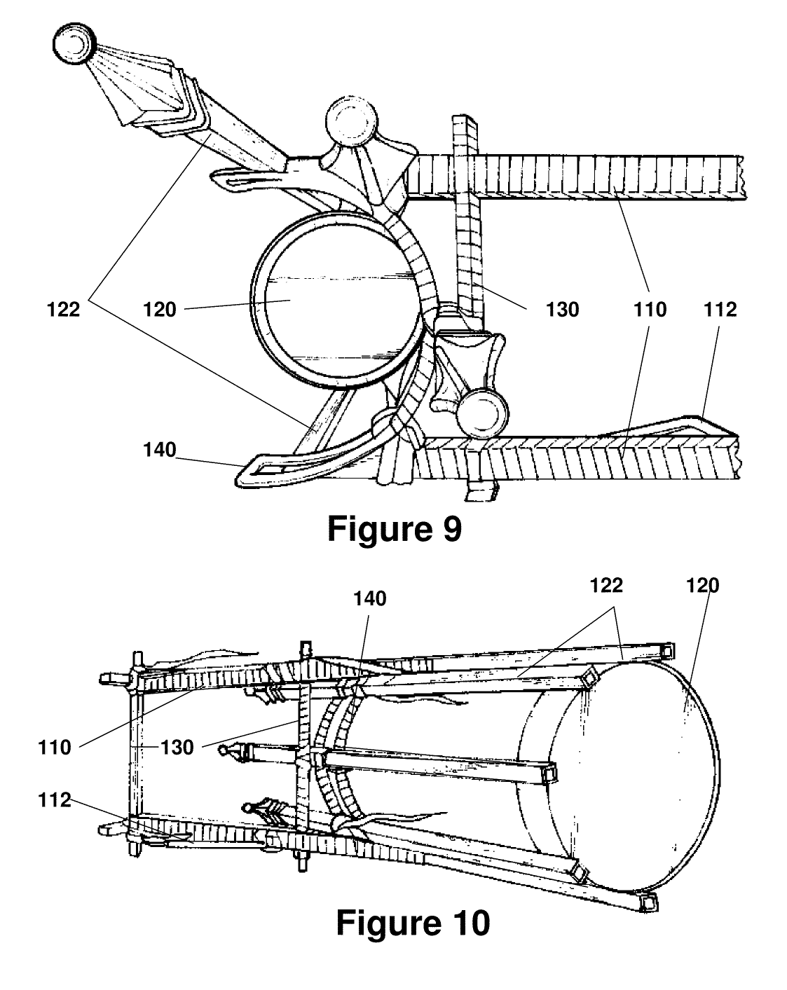

FIG. 9 shows a top view of a carrier in an embodiment of the disclosed technology, and FIG. 10 shows a bottom perspective view of a carrier in an embodiment of the disclosed technology. In an embodiment of the disclosed technology, a basket 180 is displayed that comprises of a pan 120 and surrounding spindles 122 formed in a cylindrical shape for a purpose of carrying luggage such as golf clubs and/or other objects. The basket 180 forms a unitary structure with a proximal region of two supporting arms. The distal region of a supporting arm 110 is comprised of kicker supports 112, a mounting flange 114, a mounting finger 116 extending angularly, and a plurality of supports.

In a further embodiment of the disclosed technology, an article carrier further comprises of an accessory rack, which further comprises at least three supports 130 extending between the supporting arms. In an embodiment of the disclosed technology, an accessory rack is capable of holding materials of a driver of a motorcycle, such as luggage, sporting equipment, tools, a combination thereof, and the like.

Referring again to the Figures in general, and more specifically, to FIGS. 4, 6 and 9, a securing strap 142 and securing strap holder 140 are shown. In embodiments of the disclosed technology, the securing strap holder 140 may or does form an integral part of the carrier 100 and is fixedly attached to the spindles 122, adding stability and support to them. Further, the securing strap holder 140 allows for a securing strap 142, which may be a leather or other generally flexible strap to attach to the carrier 100 and be wrapped around an article of luggage, such as is shown in FIG. 4. In this manner, the luggage is held securely to the article carrier during transport.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. An article carrier for a motorcycle comprising:
two spaced apart supporting arms, each supporting arm having a distal region and a proximal region, each said proximal region forming a unitary structure with a basket, and each said distal region comprising a mounting finger extending angularly from each said supporting arm; and
kicker supports extending substantially from each said distal and proximal region and joining at a mounting flange.

2. The article carrier of claim 1, wherein said basket further comprises a plurality of spaced apart spindles.

3. The article carrier of claim 2, further comprising a support extending from near said proximal region of said supporting arms and fixedly attached to at least three said spaced apart spindles.

4. The article carrier of claim 1, wherein each said mounting flange is adapted for engagement by a rear fender strut of said motorcycle.

5. The article carrier of claim 4, wherein each said mounting finger is adapted for engagement with a passenger rest slot of said motorcycle.

6. The article carrier of claim 1, wherein said basket is elongated.

7. The article carrier of claim 6, wherein an angle of said basket with respect to said motorcycle in an attached condition is congruent to a rake angle of said motorcycle.

8. The article carrier of claim 1, further comprising an accessory rack, said accessory rack comprising at least three supports extending between said supporting arms.

9. The article carrier of claim 1, wherein said basket is adapted to hold golf clubs.

10. The article carrier of claim 1, wherein said basket is closed at a first end and open at a second, opposite end thereof.

11. A motorcycle attachment, comprising:
a luggage compartment;
left and right mounting fingers adapted for engagement with corresponding left and right passenger rest slots of said motorcycle;
an angle of said luggage compartment congruent to a rake of said motorcycle.

12. The motorcycle attachment of claim 11, further comprising left and right supporting arms, each said arm further comprising a front and rear kicker support each forming a unitary structure with a respective left and right mounting flange.

13. The motorcycle attachment of claim 12, wherein each said mounting flange is adapted for engagement with a rear fender strut of said motorcycle.

14. The motorcycle attachment of claim 11, wherein said basket further comprises a plurality of spaced apart spindles.

15. The motorcycle attachment of claim 14, wherein said basket is elongated.

16. The motorcycle attachment of claim 11, further comprising an accessory rack, said accessory rack comprising at least three supports extending between said supporting arms.

17. The motorcycle attachment of claim 11, wherein said basket is adapted to hold golf clubs.

18. The motorcycle attachment of claim 11, wherein said basket is closed at one end and open at an opposite end thereof.

19. The motorcycle attachment of claim 11, wherein said luggage compartment further comprising a securing strap holder adapted for engagement with a securing strap.

20. The motorcycle attachment of claim 11, further comprising a securing strap holder and securing strap adapted for securing an article in said basket.
